(19) United States
(12) Patent Application Publication
(10) Pub. No.: US 2026/0060257 A1
(43) Pub. Date: Mar. 5, 2026

(54) Ergonomic Dual-Handle Pizza Peel with Integrated Cutting Board

(71) Applicant: Mustafa Khan, Odessa, FL (US)

(72) Inventor: Mustafa Khan, Odessa, FL (US)

(21) Appl. No.: 19/049,179

(22) Filed: Feb. 10, 2025

Related U.S. Application Data
(60) Provisional application No. 63/688,310, filed on Aug. 29, 2024.

(51) Int. Cl. A21B 3/00

(52) U.S. Cl. CPC A21B 3/003

(57) ABSTRACT

The present invention relates to a pizza peel with two ergonomic handles designed for dual-hand use. The ergonomic handles allow the pizza peel to be gripped from the front or sides, depending on user preference. The pizza peel features a beveled edge for easy insertion under pizza dough or baked pizzas and includes etched grooves on its surface, enabling even slicing directly on the peel.

### BACKGROUND OF THE INVENTION

Pizza peels are essential tools for transferring pizzas to and from ovens in both home and commercial kitchens. Conventional pizza peels can be bulky and difficult to maneuver, especially for users with limited grip strength. Existing peels also often lack ergonomic features for user comfort during extended use.

Additionally, most traditional pizza peels do not have built-in guides or grooves for cutting pizzas into even slices directly on the peel. Therefore, there is a need for a pizza peel that addresses both ergonomic handling and efficient slicing.

### SUMMARY OF THE INVENTION

The invention provides an ergonomic pizza peel featuring dual handles that allow for two-handed operation, reducing strain on the user's hands, wrists, and forearms. The pizza peel includes a beveled edge for easy insertion beneath pizza dough or baked pizzas. The surface of the peel incorporates a grooved cutting area that facilitates the even slicing of pizza, cheese, cake, pie, or other food items directly on the peel.

### BRIEF DESCRIPTION OF THE DRAWINGS

FIG. 1 is a front view of the pizza peel, showing the ergonomic handles, grooved cutting area, and beveled edge.

FIG. 2 is a back view of the pizza peel, illustrating the flat back surface and the handles as seen from the reverse side.

### DETAILED DESCRIPTION OF THE INVENTION

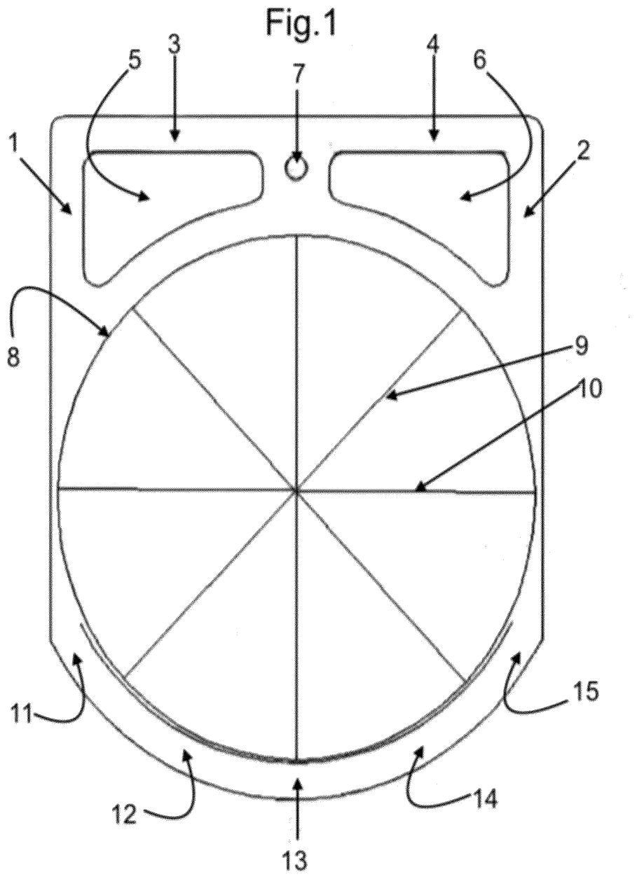

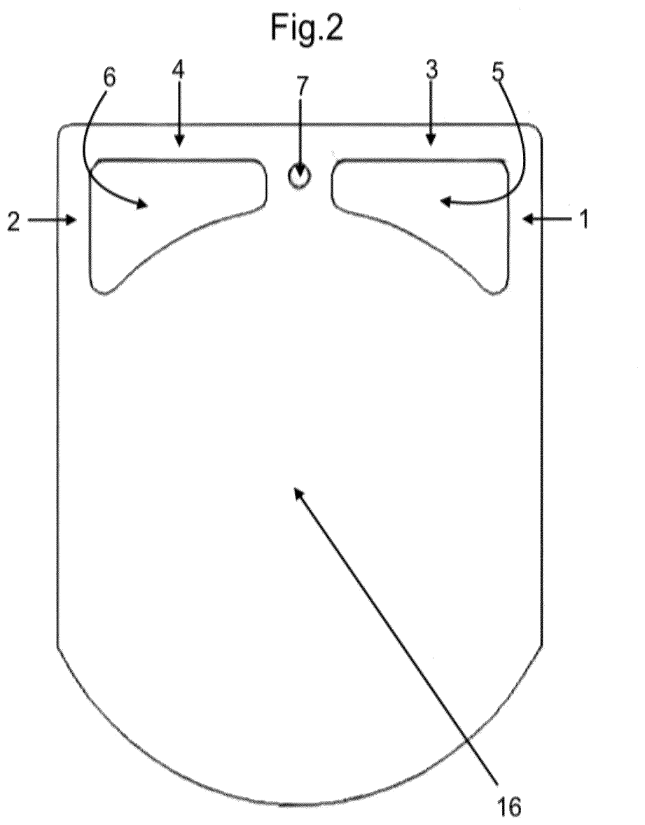

The pizza peel is depicted in FIG. 1 and FIG. 2. The peel comprises dual ergonomic handles (1, 2) on the sides and additional front handles (3, 4) that allow the user to grip the peel from either the front or the sides, based on preference.

Cut-out sections (5, 6) form the ergonomic side handles, providing comfortable gripping areas. A smaller hole (7) near the top of the peel allows it to be hung on a hook or similar storage device when not in use.

The surface of the peel includes a grooved circular area (8) where pizza or other food items can be placed for cutting. The grooves (9, 10) within this circle guide the user in slicing the food into even portions. The peel's edge (11, 12, 13, 14) is beveled to facilitate easy sliding beneath pizza dough or baked pizzas.

FIG. 2 shows the back view (16) of the pizza peel, featuring the flat back surface. The ergonomic handles (1, 2, 3, 4), handle cut-outs (5, 6), and hanging hole (7) are also visible from this perspective.

The pizza peel may be manufactured in various sizes to suit different uses, ranging from smaller personal pizza peels to larger commercial-sized peels. The dimensions of the grooved circle (8), cutting grooves (9, 10), and handles (1, 2, 3, 4) can be adjusted accordingly.

1. A pizza peel comprising:
Dual ergonomic handles (1, 2, 3, 4) allowing for two-handed operation;
A beveled edge (11, 12, 13, 14) for sliding under pizza dough and baked pizzas;
A grooved circular cutting area (8) with straight grooves (9, 10) for evenly slicing pizza, cake, pie, and other food items;
A hanging hole (7) for convenient storage;
Constructed from any suitable material for pizza handling and cutting.

2. The pizza peel of claim 1, wherein the ergonomic handles (1, 2, 3, 4) are designed to reduce hand fatigue during extended use by allowing for various hand placements, including both front and side grips.

3. The pizza peel of claim 1, wherein the grooved circle (8) and straight cutting grooves (9, 10) enable the user to cut pizza and other food items into even slices directly on the peel.
